(19) United States
(12) Patent Application Publication
(10) Pub. No.: US 2019/0157707 A1
(43) Pub. Date: May 23, 2019

(54) SECONDARY INTERCONNECT FOR FUEL CELL SYSTEMS

(71) Applicant: LG Fuel Cell Systems, Inc., North Canton, OH (US)

(72) Inventors: Zhien Liu, Canal Fulton, OH (US); Rich Goettler, Medina, OH (US); Gerry Agnew, Uttoxeter (GB); Peter Dixon, Derby (GB)

(73) Assignee: LG Fuel Cell Systems, Inc., North Canton, OH (US)

(21) Appl. No.: 15/816,937

(22) Filed: Nov. 17, 2017

(51) Int. Cl. H01M 8/2483; H01M 8/1253; H01M 8/2428

(52) U.S. Cl. CPC H01M 8/2483; H01M 2008/1293; H01M 8/2428; H01M 8/1253

(57) ABSTRACT

A fuel cell system is provided. The fuel cell system may be a segmented-in-series, solid-oxide fuel cell system. The system may comprise a fuel cell tube and a secondary interconnect. The fuel cell tube may comprise a substrate, a fuel channel, a first and second electrochemical active fuel cell, a primary interconnect, and an electrochemically inactive cell. The substrate may have a major surface. The fuel channel may be separated from the major surface by the substrate. The first and second electrochemically active fuel cells may be disposed on the major surface, and may comprise and anode, a cathode, and an electrolyte disposed between the anode and the cathode. The primary interconnect may electrically couple the anode of the first electrochemically active fuel cell to the cathode of a second electrochemically active fuel cell. The electrochemically inactive fuel cell may be disposed on the major surface and comprise a conductive layer electrically coupled to the second electrochemically active fuel cell. The secondary interconnect may be coupled to the conductive layer of the electrochemically inactive cell. The electrochemically inactive cell is configured to inhibit the migration of hydrogen from said fuel channel to the secondary interconnect.

### RELATED APPLICATIONS

This application is related to concurrently filed and co-pending U.S. application Ser. No. ______, filed Nov. 17, 2017, entitled “Multiple Fuel Cell Secondary Interconnect Bonding Pads and Wires,” bearing Docket Number G3541-00244/FCA12024, with named inventors Gerry Agnew, U.S. application Ser. No. ______, filed Nov. 17, 2017, entitled “Fuel Cell Ink Trace Interconnect,” bearing Docket Number G3541-00245/FCA12023, with named inventors Ed Daum, U.S. application Ser. No. ______, filed Nov. 17, 2017, entitled “Improved Fuel Cell Secondary Interconnect,” bearing Docket Number G3541-00181/FCAG11711, with named inventors Zhien Liu, Rich Goettler, Ed Daum, and Charles, Osborn, and U.S. application Ser. No. ______, filed Nov. 17, 2017, entitled “Improved Fuel Cell Secondary Interconnect,” bearing Docket Number G3541-00246/FCAG11979, with named inventors Zhien Liu, Rich Goettler, the entirety of all these applications is incorporated herein by reference.

### GOVERNMENT LICENSE RIGHTS STATEMENT

This invention was made with Government support under Assistance Agreement No. DE-FE0000303 awarded by Department of Energy. The Government has certain rights in this invention.

### TECHNICAL FIELD

The disclosure generally relates to fuel cells, such as solid oxide fuel cells.

### BACKGROUND

Fuel cells, fuel cell systems, and interconnects for fuel cells and fuel cell systems remain an area of interest. Some existing systems have various shortcomings, drawbacks, and disadvantages relative to certain applications. Accordingly, there remains a need for further contributions in this area of technology.

### SUMMARY

The disclosure describes secondary interconnects for fuels cells, such as, for example, integrated planar solid oxide fuels cells.

In accordance with some embodiments of the present disclosure, a fuel cell system is provided. The fuel cell system may be a segmented-in-series, solid-oxide fuel cell system. The system may comprise a fuel cell tube and a secondary interconnect. The fuel cell tube may comprise a substrate, a fuel channel, a first and second electrochemical active fuel cell, a primary interconnect, and an electrochemically inactive cell. The substrate may have a major surface. The fuel channel may be separated from the major surface by the substrate. The first and second electrochemically active fuel cells may be disposed on the major surface, and may comprise and anode, a cathode, and an electrolyte disposed between the anode and the cathode. The primary interconnect may electrically couple the anode of the first electrochemically active fuel cell to the cathode of a second electrochemically active fuel cell. The electrochemically inactive fuel cell may be disposed on the major surface and comprise a conductive layer electrically coupled to the second electrochemically active fuel cell. The secondary interconnect may be coupled to the conductive layer of the electrochemically inactive cell. The electrochemically inactive cell is configured to inhibit the migration of hydrogen from said fuel channel to the secondary interconnect.

In accordance with some embodiments of the present disclosure, a segmented-in-series fuel cell system is provided. The system may comprise a substrate having a first major surface second major surface, a fuel channel disposed between the first and second major surfaces, wherein the fuel channel is separated from the first and second major surfaces by the substrate, a first and second electrochemically active fuel cells disposed on the first major surface and a third and fourth electrochemically active fuel cells disposed on the second major surface, each of the electrochemically active fuel cells comprising an anode, a cathode, and an electrolyte disposed between said anode and said cathode, a first primary interconnect electrically coupling the anode of the first electrochemically active fuel cell to the cathode of the second electrochemically active fuel cell, a second primary interconnect electrically coupling the anode of the third electrochemically active fuel cell to the cathode of the fourth electrochemically active fuel cell, a first electrochemically inactive cell disposed on the first major surface and a second electrochemically inactive cell disposed on the second major surface, each of the electrochemically inactive cells comprising a conductive layer electrically coupled to at least one of the electrochemically active fuel cells, and a secondary interconnect electrically coupled to the conductive layer of the first and second electrochemically inactive cells, wherein the electrochemically inactive cells are configured to inhibit migration of hydrogen from the fuel channel to the secondary interconnect.

In accordance with some embodiments of the present disclosure, a fuel cell tube is provided. The fuel cell tube may comprise a substrate having a major surface, a fuel channel separated from the major surface by the substrate, at least one electrochemically active cell disposed on the major surface comprising, the electrochemically active cell comprising an anode, a cathode, and an electrolyte disposed between the anode and the cathode, an electrochemically inactive cell disposed on the major surface, the electrochemically inactive cell comprising a conductive layer, an electrolyte disposed between said conductive layer and the major surface of said substrate, and a dense barrier disposed between the electrolyte and the major surface of said substrate, and a primary interconnect electrically coupling the anode of the electrochemically active cell and the conductive layer. The tube may further comprise a secondary interconnect comprising palladium electrically coupled to the conductive layer of the electrochemically inactive cell, wherein the secondary interconnect is at least partly buried by a conductive bonding paste.

In one aspect, the disclosure describes a fuel cell system that includes at least a first fuel cell tube and a second fuel cell tube. The first fuel cell tube includes a substrate, a fuel channel, and a first fuel cell formed on the substrate. The substrate separates the first fuel cell from the fuel channel. The first fuel cell includes a cathode, an electrolyte, an anode that is separated from the cathode by the electrolyte. A primary interconnect adjacent the anode electrically couples the anode of the first fuel cell to a cathode conductive layer adjacent to the first fuel cell. A secondary interconnect is formed on and electrically coupled to the cathode conductive layer. The secondary interconnect is configured to electrically couple the first fuel cell tube and the second fuel cell tube. The cathode conductive layer is disposed between the secondary interconnect and an electrolyte or dense barrier that is configured to inhibit the migration of hydrogen from the fuel channel into the secondary interconnect.

In another aspect, the disclosure describes a fuel cell system that includes at least a first fuel cell tube and a second fuel cell tube. The first fuel cell tube includes a substrate, a fuel channel, and a first fuel cell formed on the substrate. The substrate separates the first fuel cell from the fuel channel. The first fuel cell includes a cathode, an electrolyte, an anode separated from the cathode by the electrolyte. A primary interconnect adjacent the anode electrically couples a secondary interconnect conductive layer to the anode. A secondary interconnect is formed on and electrically coupled to the secondary interconnect conductive layer. The secondary interconnect is configured to electrically couple the first fuel cell tube and the second fuel cell tube. The secondary interconnect conductive layer is disposed between the secondary interconnect and an electrolyte or dense barrier that is configured to inhibit the migration of hydrogen from the fuel channel into the secondary interconnect.

### BRIEF DESCRIPTION OF DRAWINGS

The description herein makes reference to the accompanying drawings wherein like reference numerals refer to like parts throughout the several views.

FIG. 1 is a schematic diagram illustrating an example portion of fuel cell system in accordance with the present disclosure.

FIG. 2 is a schematic diagram illustrating an example cross section of a portion of a fuel cell system in accordance with the present disclosure.

FIG. 3A-3D are schematic diagrams illustrating example cross sections of a portion of a fuel cell system in accordance with the present disclosure.

FIG. 4A-4D are schematic diagrams illustrating example cross sections of a portion of a fuel cell system in accordance with the present disclosure.

FIG. 5A-5D are schematic diagrams illustrating example cross sections of a portion of a fuel cell system in accordance with the present disclosure.

FIG. 6 is a schematic diagram illustrating an example cross section of a portion of a fuel cell tube of a fuel cell system in accordance with the present disclosure.

FIG. 7 is a schematic diagram illustrating an example top view of a fuel cell system in accordance with the present disclosure.

FIG. 8 is a schematic diagram illustrating an example top view of a fuel cell system in accordance with the present disclosure.

FIG. 9 is a photograph illustrating an example of a secondary interconnect wire attachment and location on a fuel cell tube of a fuel cell system in accordance with the present disclosure.

FIG. 10 is a SEM image illustrating an example of the microstructure of a secondary interconnect wire after operation of a fuel cell system in accordance with the present disclosure.

FIG. 11 is a plot illustrating results of an experiment carried out on a fuel cell system in accordance with the present disclosure.

FIG. 12 is a schematic diagram of a fuel cell system having a SIC wire.

FIGS. 13A and 13B illustrate hydrogen-flux damage to an SIC Wire.

Referring to the drawings, some aspects of a non-limiting example of a fuel cell system in accordance with the present disclosure are schematically depicted. In the drawing, various features, components and interrelationships therebetween of aspects of an example of the present disclosure are depicted. However, the present disclosure is not limited to the particular examples presented and the components, features and interrelationships therebetween as are illustrated in the drawings and described herein.

### DETAILED DESCRIPTION

As described above, examples of the present disclosure relate to example secondary interconnects for fuels cells, such as, e.g., solid oxide fuels cells (SOFCs) and integrated planar SOFCs, and the manner in which secondary interconnects are connected to fuel cells and fuel cell tubes.

An electrochemical cell, such as a fuel cell, converts chemical energy into electrical energy and includes an anode, cathode and electrolyte. In some examples, each fuel cell may provide about one voltage depending on the fuel composition. Each cell may generate from around several hundred milliwatts to around several hundred watts of power depending on cell area, cell internal resistance, operating voltage, and the like. To provide higher voltage and generate more power, individual cells may be connected in series through one or more interconnects. Interconnects may be a suitable electronic conductor that allows for the transport electrons from one cell to another.

A primary interconnect may connect a first fuel cell to a second fuel cell on a fuel cell tube or substrate. In an integrated planar SOFC, all active fuel cell layers (e.g., anode, electrolyte and cathode) may be disposed on inert porous ceramic substrate, which may be a flat tube, circular tube, or the like. If the substrate is flat tube, fuel cells may be deposited on both sides of the substrate. A plurality of fuel cells may be disposed on a substrate, wherein each individual fuel cell is connected to at least one adjacent fuel cell through a primary interconnect. This design is also known as a segmented-in-series SOFC.

To form relatively large fuel cell systems having, for example, from combined total power output (heat and electrical) of 1 kilowatt (kW) to 5 kW and larger distributed power generation systems having a total power output of 100 kW to 1 MW, multiple fuel cell tubes may be connected to form a fuel cell bundle, multiple fuel cell bundles may be connected to form a fuel cell strip, multiple fuel cell strips may be connected to form a fuel cell block, and multiple fuel cell blocks may be connected to form a fuel cell generator module. Connecting multiple fuel cell tubes, multiple fuel cell bundles, multiple fuel cell strips, or multiple fuel cell blocks may allow a fuel cell system to generate higher voltage and more power.

In integrated planar SOFCs, the connection between fuel cell tubes may be called a secondary interconnect. The term secondary interconnect may also refer to the connections between fuel cells on opposite sides of the same fuel cell tube. The connections between fuel cell strips, fuel cell bundles, or fuel cell blocks may be called a tertiary interconnect.

As will be described further below, some examples of the disclosure relate to the connection between tubes, or the cell connections between tubes, including, e.g., the cell connection on two sides of the tubes.

Fuel cell systems may include a secondary interconnect at a location on an anode side of a fuel cell tube, for example, by bonding the secondary interconnect to an anode conductive layer (anode current collector, or ACC) with conductive bonding paste and covering the contact point with sealing glass. The sealing glass may provide a gastight barrier to separate the oxidant side (air side) and fuel side (hydrogen flow channel) of the fuel cell system. However, the fuel may have a high fuel flux, e.g., of hydrogen, through the fuel cell components to the secondary interconnect, and the secondary interconnect may comprise a material through which the fuel may readily migrate to the oxidant side of the fuel cell system. This migrated fuel may then combine with the oxidant and burn at or near the surface of the secondary interconnect. Burning of the fuel at or near the surface of the secondary interconnect may result in a microstructural change to the secondary interconnect caused by the formation of localized hot spots. This microstructural change to the secondary interconnect may result in loss of conductivity of the secondary interconnect, as well as loss of mechanical strength or mechanical failure of the secondary interconnect, leading to a less robust product.

To maintain mechanical integrity and electrical conductivity of the secondary interconnect, structures, systems, components and methods may be employed that separate the secondary interconnect from the fuel channel to prevent a hydrogen fuel flux from reaching the secondary interconnect.

Examples of the disclosure are directed to fuel cell systems that inhibit the flux of hydrogen fuel into the secondary interconnect by providing structures, systems, components and methods that prevent the flux of hydrogen to the secondary interconnect. In some embodiments, an electrochemically inactive cell (aka “dummy cell”) may be disposed between the secondary interconnect and the fuel cell system fuel channel Some embodiments of the disclosure are also directed to fuel cell systems that include any one of a dense barrier and an electrolyte, either of which may be configured to inhibit the flow of hydrogen, or another fuel, from the fuel channel into the secondary interconnect.

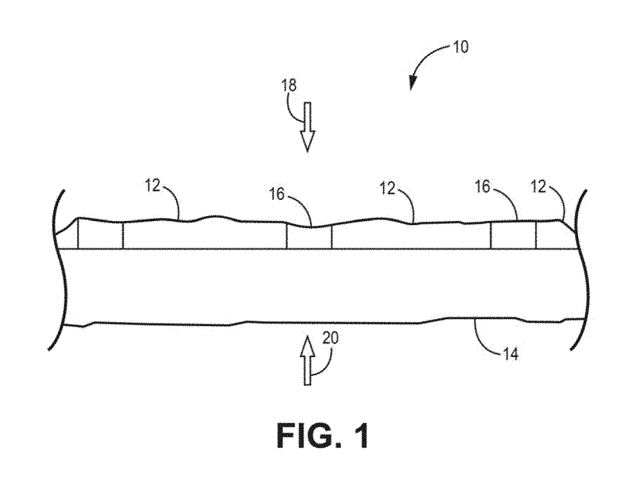

FIG. 1 is a schematic diagram illustrating an example fuel cell system 10 in accordance with the present disclosure. As shown in FIG. 1, fuel cell system 10 includes a plurality of electrochemical cells 12 (“fuel cells 12”) formed on substrate 14. Fuel cells 12 are coupled together in series by primary interconnect 16. Fuel cell system 10 is a segmented-in-series arrangement in which fuel cells are deposited on a flat, porous ceramic tube, although it will be understood that the present disclosure is equally applicable to segmented-in-series arrangements on other substrates, such on a circular porous ceramic tube. In various examples, fuel cell system 10 may be an integrated planar fuel cell system or a tubular fuel cell system.

The fuel cell system 10 includes an oxidant side 18 and a fuel side 20. The oxidant is generally air, but could also be pure oxygen (02) or other oxidants, including, for example, diluted air generated in the fuel cell or by supporting systems, e.g. by having one or more air recycle loops. The oxidant may be supplied to fuel cells 12 from oxidant side 18. During fuel cell 12 operation, the oxidant side 18 may define an oxidizing environment. The oxidizing environment may include oxygen partial pressures of 0.1 to 0.9 bar and 0.2 to 0.6 bar and temperatures of 700 to 1000 degrees centigrade and 800-900 degrees centigrade.

A fuel, such as a reformed hydrocarbon fuel or synthesis gas, is supplied to fuel cells 12 from fuel side 20 via fuel channels (not shown) in porous substrate 14.

Although oxidant (e.g. air) and fuel (e.g., synthesis gas that may be reformed from a hydrocarbon fuel) are described above, it will be understood that electrochemical cells using other oxidants and fuels may be employed without departing from the scope of the present disclosure, such as, for example, pure hydrogen and pure oxygen. In addition, although fuel is supplied to fuel cells 12 via substrate 14, it will be understood that in some examples, the oxidant may be supplied to the electrochemical cells via a porous substrate.

Substrate 14 may comprise a ceramic material having a specific porosity, and may be stable at fuel cell operation conditions and chemically compatible with other fuel cell materials. In some examples, substrate 14 may be a surface-modified material, for example, a porous ceramic material having a coating or other surface modification, such as, for example, being configured to prevent or reduce interaction between fuel cell 12 components and substrate tube.

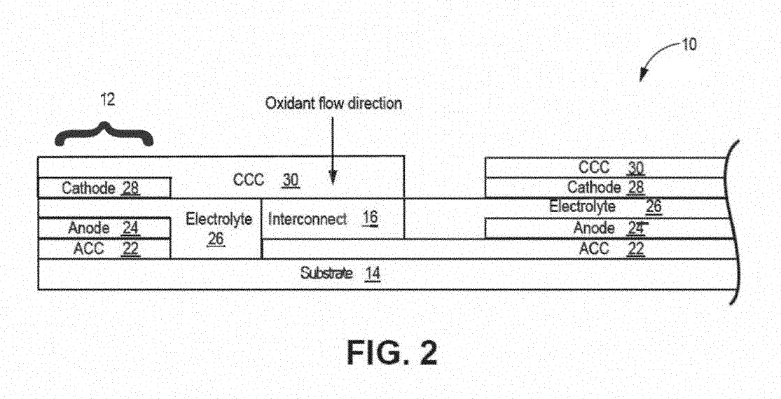

FIG. 2 is a schematic diagram illustrating an example cross section of fuel cell system 10 in accordance with the present disclosure. Fuel cell system 10 may be formed of a plurality of components printed onto substrate 14. This printing may include a process whereby a woven mesh having openings through which the fuel cell layers are deposited is placed onto substrate 14. The openings of the screen determine the length and width of the printed layers. Screen mesh, wire diameter, ink solids loading and ink rheology may determine the thickness of the printed layers. Fuel cell system 10 layers include an anode conductive layer 22 (also referred to as an anode current collector or “ACC”), an anode 24, an electrolyte 26, a cathode 28 and a cathode conductive layer 30 (also referred to as a cathode current collector or “CCC”). In one form, electrolyte 26 may be a single layer or may be formed of any number of sub-layers. It will be understood that FIG. 2 is not necessarily to scale. For example, horizontal and vertical dimensions are exaggerated for purposes of clarity of illustration.

In each fuel cell, ACC 22 conducts free electrons away from anode 24 and conducts the electrons to the cathode conductive layer 30 of an adjacent cell via primary interconnect 16. Cathode conductive layer 30 conducts the electrons to cathode 28. Primary interconnect 16 is electrically coupled to anode conductive layer 22 and to cathode conductive layer 30.

For SOFCs, primary interconnects are preferably electrically conductive in order to transport electrons from one electrochemical cell to another; mechanically and chemically stable under both oxidizing and reducing environments during fuel cell operation; and nonporous, in order to prevent diffusion of the fuel and/or oxidant through the interconnect. If the interconnect is porous, fuel may diffuse to the oxidant side and burn, resulting in local hot spots that may result in degradation of materials and mechanical failure, reduced efficiency of the fuel cell system, or reduced fuel cell life. Similarly, the oxidant may diffuse to the fuel side, resulting in burning of the fuel. Severe interconnect leakage may significantly reduce the fuel utilization and performance of the fuel cell, or cause catastrophic failure of fuel cells or stacks.

Primary interconnect 16 may be formed of a precious metal, including, for example, Ag, Pd, Au, or Pt, although other materials may be employed without departing from the scope of the present disclosure. For example, it is alternatively contemplated that other materials may be employed, including precious metal alloys, such as Ag—Pd, Ag—Au, Ag—Pt, Au—Pd, Au—Pt, Pt—Pd, Ag—Au—Pd, Ag—Au—Pt, Ag—Au—Pd—Pt, as well as binary, ternary, or quaternary alloys in the Pt—Pd—Au—Ag family, inclusive of alloys having minor non-precious metal additions, cermets composed of a precious metal, precious metal alloy, and an inert ceramic phase, such as alumina, or ceramic phase with minimum ionic conductivity which will not create significant parasitics, such as YSZ (yttria stabilized zirconia, also known as yttria doped zirconia, wherein yttria doping is 3-8 mol %, preferably 3-5 mol %), ScSZ (scandia stabilized zirconia, wherein scandia doping is 4-10 mol %, preferably 4-6 mol %), doped ceria, and/or conductive ceramics, such as conductive perovskites with A or B-site substitutions or doping to achieve adequate phase stability and/or sufficient conductivity as an interconnect, e.g., including at least one of doped strontium titanate (such as LaₓSr₁₋ₓTiO_{3-δ}, x=0.1 to 0.3), LSCM (La₁₋ₓSrxCr_{1-y}Mn_{y}O₃, x=0.1 to 0.3 and y=0.25 to 0.75), doped yttrium chromites (such as Y₁₋ₓCaₓCrO_{3-δ}, x=0.1-0.3) and/or other doped lanthanum chromites (such as La₁₋ₓCaₓCrO_{3-δ}, where x=0.15-0.3), and conductive ceramics, such as doped strontium titanate, doped yttrium chromites, LSCM (La₁₋ₓSrₓCr_{1-y}Mn_{y}O₃), and other doped lanthanum chromites. In one example, primary interconnect 16 may be formed of y(PdxPt1-x)-(1-y)YSZ. Where x is from 0 to 1 in weight ratio, and preferably x is in the range of 0 to 0.5 for lower hydrogen flux. Y is from 0.35 to 0.80 in volume ratio, and preferably y is in the range of 0.4 to 0.6.

Anode conductive layer 22 may be an electrode conductive layer formed of a nickel cermet, such as such as Ni-YSZ (e.g., where yttria doping in zirconia is 3-8 mol %), Ni-ScSZ (e.g., where scandia doping is 4-10 mol %, preferably including a second dopant, for example, 1 mol % ceria for phase stability for a 10 mol % scandia-ZrO₂) and/or Ni-doped ceria (such as Gd or Sm doping), doped lanthanum chromite (such as Ca doping on A site and Zn doping on B site), doped strontium titanate (such as La doping on A site and Mn doping on B site), La₁₋ₓSrₓMn_{y}Cr_{1-y}O₃ and/or Mn-based R-P phases of the general formula a (La₁₋ₓSrₓ)ₙ₊₁MnₙO₃ₙ₊₁. Alternatively, it is considered that other materials for anode conductive layer 22 may be employed such as cermets based in part or whole on precious metal, nickel, or both. Precious metals in the cermet may include, for example, Pt, Pd, Au, Ag, and/or alloys thereof. The ceramic phase may include, for example, an inactive, non-electrically conductive phase, including, for example, YSZ, ScSZ and/or one or more other inactive phases. These ceramic phases may have a coefficient of thermal expansion (CTE) that helps control the combined CTE of ACC 22 to match, or better match, the CTE of the substrate 14 and/or electrolyte 26. In some examples, the ceramic phase may include Al₂O₃ and/or a spinel such as NiAl₂O₄, MgAl₂O₄, MgCr₂O₄, and NiCr₂O₄. In some examples, the ceramic phase may be electrically conductive, e.g., doped lanthanum chromite, doped strontium titanate and/or one or more forms of LaSrMnCrO and/or R-P phases of the general formula (La₁₋ₓSrₓ)ₙ₊₁MnₙO₃ₙ₊₁.

Electrolyte 26 may be made from a ceramic material. In one form, a proton and/or oxygen ion conducting ceramic may be employed. In one form, electrolyte 26 is formed of YSZ, such as 3YSZ and/or 8YSZ. In some examples, electrolyte 26 may be formed of ScSZ, such as 4ScSZ, 6ScSz and/or 10Sc1CeSZ in addition to or in place of YSZ. In some examples, other materials may be employed. For example, it is considered that electrolyte 26 may be made of doped ceria and/or doped lanthanum gallate. In any event, electrolyte 26 is substantially impervious to diffusion therethrough of the fluids used by fuel cell system 10, e.g., synthesis gas or pure hydrogen as fuel, as well as, e.g., air or O₂ as an oxidant, while still allowing diffusion of oxygen ions or protons.

Cathode conductive layer 30 may be an electrode conductive layer formed of a conductive ceramic, for example, at least one of LaNiₓFe₁₋ₓO₃ (such as, e.g., LaNi_{0.6}Fe_{0.4}O₃), La₁₋ₓSrₓMnO₃ (such as La_{0.75}Sr_{0.25}MnO₃), La₁₋ₓSrₓCoO₃ and/or Pr₁₋ₓSrₓCoO₃ (such as Pr_{0.8}Sr_{0.2}CoO₃). In some examples, cathode conductive layer 30 may be formed of other materials, e.g., a precious metal cermet, although other materials may be employed without departing from the scope of the present invention. The precious metals in the precious metal cermet may include, for example, Pt, Pd, Au, Ag and/or alloys thereof. The ceramic phase may include, for example, YSZ, ScSZ and Al₂O₃, or other non-conductive ceramic materials as desired to control thermal expansion.

Any suitable technique may be employed to form fuel cell system 10 of FIGS. 1 and 2. For example, anode conductive layer 22 and a portion of the electrolyte 26 may be printed directly onto substrate 14. Anode 24 may be printed onto anode conductive layer 22. Some portions of electrolyte 26 may be printed onto anode 24, and some portions of electrolyte 26 may be printed onto anode conductive layer 22, substrate 14, or both. Cathode 28 may be printed on top of electrolyte 26. Some portions of cathode conductive layer 30 may be printed onto cathode 28, and some portions may be printed onto electrolyte 26. Cathode 28 is spaced apart from anode 24 the local thickness of electrolyte 26. Primary interconnect 16 may be printed on ACC 22. A portion of the CCC 30 may be printed on interconnect 16.

A gap may separate anodes 24 of adjacent fuel cells. Similarly, a gap may separate cathodes 28 of adjacent fuel cells. Each fuel cell 12 is formed of an anode 24 and the cathode 28 spaced apart by a portion of electrolyte 26.

Similarly, ACC 22 (also known as an anode conductor film) and CCC 30 (also known as a cathode conductor film) may have respective gaps between adjacent ACCs 22 and CCCs 30. The terms, “anode conductive layer” and “anode conductor film” may be used interchangeably.

In some examples, anode conductive layer 22 has a thickness of approximately 5-15 microns, although other values may be employed without departing from the scope of the present disclosure. For example, the anode conductive layer may have a thickness in the range of approximately 5-50 microns. In some examples, different thicknesses may be used, for example, depending upon the particular material and application.

Similarly, anode 24 may have a thickness of approximately 5-20 microns, although some values may be employed without departing from the scope of the present invention. In some examples, the anode may have a thickness in the range of approximately 5-40 microns. In some examples, different thicknesses may be used, for example, depending upon the particular anode material and application.

Electrolyte 26 may have a thickness of approximately 5-15 microns with minimum individual sub-layer thicknesses of approximately 5 microns. Other thickness values may be employed without departing from the scope of the present invention. For example, the electrolyte may have a thickness in the range of approximately 5-200 microns. In some examples, different thicknesses may be used, for example, depending upon the particular materials and application.

Cathode 28 may have a thickness of approximately 3-30 microns, such as, for example, approximately 5-10 microns. Other values may be employed without departing from the scope of the present invention. For example, the cathode may have a thickness in the range of approximately 10-50 microns. In some examples, different thicknesses may be used, for example, depending upon the particular cathode material and application.

Cathode conductive layer 30 has a thickness of approximately 5-100 microns, although other values may be employed without departing from the scope of the present invention. For example, the cathode conductive layer may have a thickness less than or greater than the range of approximately 5-100 microns. In some examples, different thicknesses may be used, for example, depending upon the particular cathode conductive layer material and application.

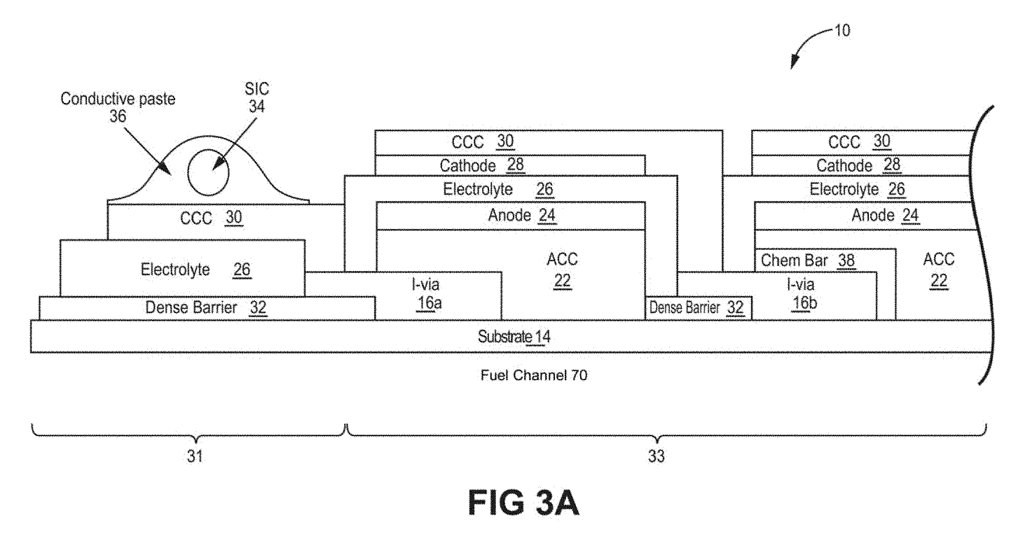

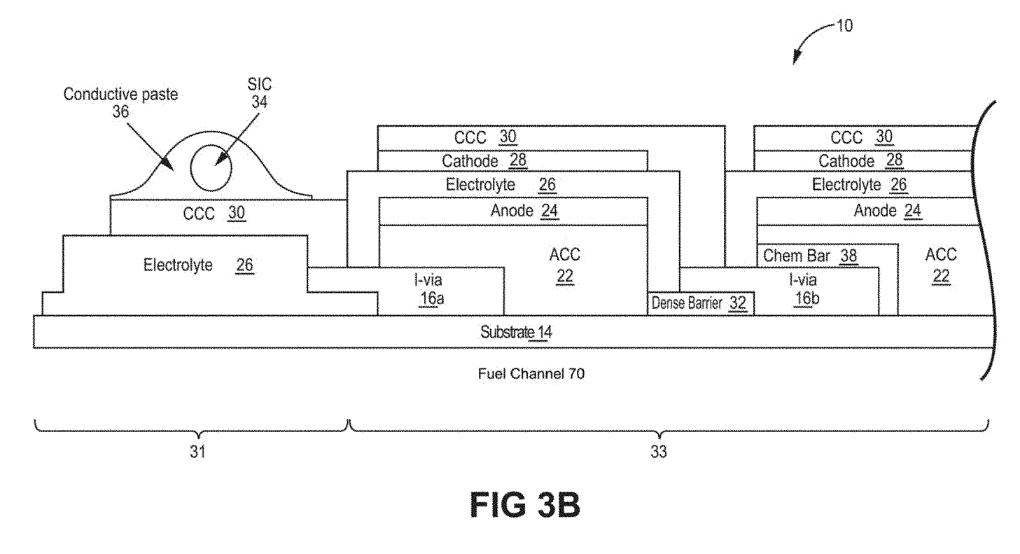

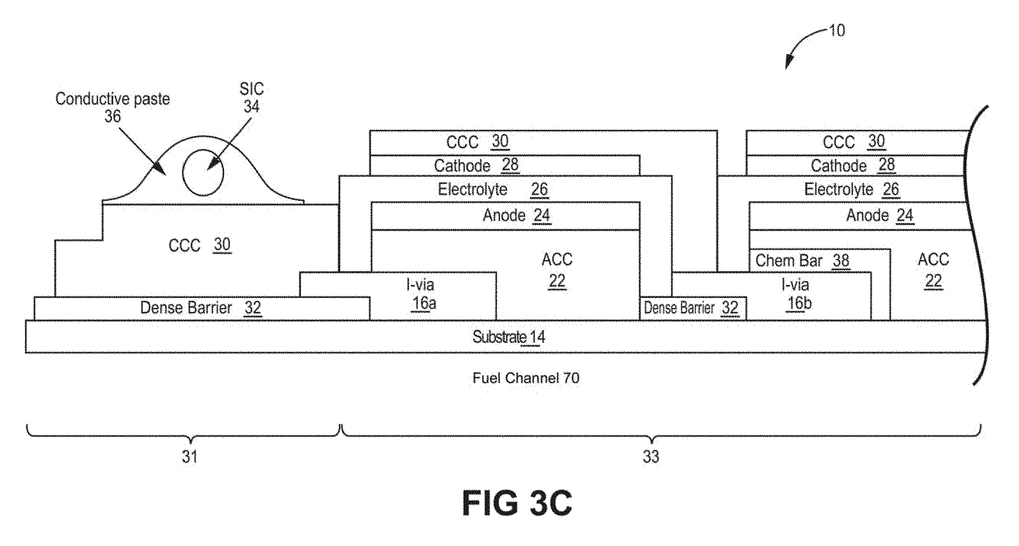

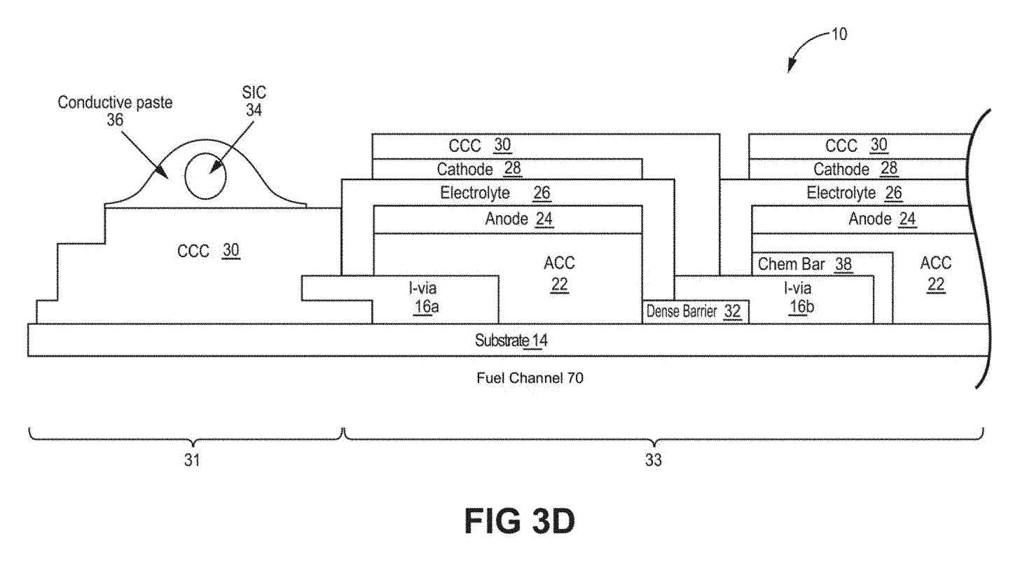

FIGS. 3A-3D are schematic diagrams illustrating an example cross section of a portion of a fuel cell system 10 in accordance with the present disclosure. Fuel cell system 10 may include plurality of fuel cells, each comprising an anode conductive layer 22, an anode 24, an electrolyte 26, a cathode 28 and a cathode conductive layer 30, as described above with respect to FIG. 2. The fuel cells may be deposited or printed on a substrate 14 that separates the fuel cells from a fuel channel 70. Adjacent fuel cells may be electrically coupled by a primary interconnect (or “I-Via”) 16b. The fuel cell system and individual fuel cells may further comprise a dense barrier 32 and chemical barrier 38. Dense barrier 32 separates at least a portion of the primary interconnect 16 from the substrate 14 and functions to inhibit the flow of fuel or other gasses to the primary interconnect 16. Chemical barrier 38 is disposed between the primary interconnect 16 and the anode 24, ACC 22, or both and functions to inhibit the transfer of material from which the interconnect 16 is composed into the ACC 22, anode 24, or both, and/or the transfer of material from which the ACC 22 is composed, material from which the anode 24 is composed, or both into the interconnect 16. The fuel cell tube may be divided into “active” portions 33 that contain electrochemically active fuel cells during operations and “inactive” portions 31 that do not contain the necessary structure, components, or both to support the fuel cell electrochemical reactions.

The fuel cell system 10 may further comprise a secondary interconnect 34, and conductive bonding paste 36.

It will be understood that FIGS. 3A-3D are not necessarily to scale. For example, horizontal and vertical dimensions are exaggerated for purposes of clarity of illustration.

As shown in FIG. 3A-3D, secondary interconnect 34 may be disposed on cathode conductive layer 30. In some examples, secondary interconnect 34 may be formed directly on cathode conductive layer 30. In some examples, secondary interconnect 34 may be formed directly on a layer other than cathode conductive layer 30, such as a precious metal bonding layer (not shown). Secondary interconnect 34 is electrically conductive to allow for the transport electrons from one fuel cell tube to another or from one side of a fuel cell tube to another side of the same fuel cell tube, mechanically stable in oxidizing environments during fuel cell operation, and chemically stable in oxidizing environments during fuel cell operation. In some examples, secondary interconnect 34 may be formed of a precious metal, including, for example, Ag, Pd, Au, or Pt, although other materials may be employed without departing from the scope of the present disclosure. For example, it is contemplated that other materials may be employed, including precious metal alloys, such as Ag—Pd, Ag—Au, Ag—Pt, Au—Pd, Au—Pt, Pt—Pd, Ag—Au—Pd, Ag—Au—Pt, Ag—Au—Pd—Pt, as well as binary, ternary, or quaternary alloys in the Pt—Pd—Au—Ag family, inclusive of alloys having minor non-precious metal additions, or cermets composed of a precious metal. In some examples, secondary interconnect 34 may be a wire, ribbon, mesh, foam or the like.

As shown in FIG. 3A-3D, conductive bonding paste 36 may be disposed on or around secondary interconnect 34, in whole or in part, to mechanically bond and electrically couple secondary interconnect 34 to cathode conductive layer 30. Conductive bonding paste is electrically conductive in order to transport electrons from the fuel cells to secondary interconnect 34, mechanically stable in oxidizing environments during fuel cell operation, and chemically stable in oxidizing environments during fuel cell operation. In some examples, conductive bonding paste 36 may include a precious metal, such as, for example, Ag, Pd, Au, or Pt, although other materials may be employed without departing from the scope of the present disclosure. For example, it contemplated that other bonding paste materials may be employed, including precious metal alloys, such as Ag—Pd, Ag—Au, Ag—Pt, Au—Pd, Au—Pt, Pt—Pd, Ag—Au—Pd, Ag—Au—Pt, Ag—Au—Pd—Pt, as well as binary, ternary, or quaternary alloys in the Pt—Pd—Au—Ag family, inclusive of alloys having minor non-precious metal additions. In some embodiments, conductive bonding past 36 may comprise a precious metal cermet including the above mentioned previous-metal alloys with a conductive ceramic, such as LSM, PSM, LNF, LSF, LSCF, LSC etc, inert ceramic, such as YSZ, ScSZ, CSZ, Al2O3, etc, or glass-ceramic which may comprise at least one of CaO, Al2O3, SiO2, BaO, or conductive ceramics, such as LSM, PSM, LNF, LSF, LSCF, LSC, etc.

As shown in FIGS. 3A-3D, fuel cell system 10 may include one or more chemical barrier 38 between primary interconnect 16 and adjacent components, such as, for example anode conductive layer 22, to reduce or prevent diffusion between the interconnect 16 and adjacent components. In various examples, chemical barrier 38 may be configured to prevent or reduce material migration or diffusion at the interface between the primary interconnect 16 and anode 24, and/or between primary interconnect 16 and anode conductive layer 22, and/or between the primary interconnect 16 and cathode 28, and/or between the primary interconnect 16 and a cathode conductive layer 30, which may improve the long term durability of the secondary interconnect. As will be understood, the chemical barrier 38 may be placed in locations other than those shown in FIGS. 3A-3D in order to provide the above mentioned functions, particularly between the interconnect 16 and the component with which material migration would otherwise occur. In some examples, fuel cell system 10 may not include chemical barrier 38.

Although not shown in FIGS. 3A-3D, in some examples, fuel cell system 10 may include one or more chemical barrier 38 between secondary interconnect 34 and adjacent components to reduce or prevent diffusion between the interconnect and adjacent components. For example, anode 24 and/or an anode conductive layer 22 and/or cathode 28 and/or cathode conductive layer 30, may adversely affect the performance of certain fuel cell systems. In various examples, chemical barrier 38 may be configured to prevent or reduce material migration or diffusion at the interface between the secondary interconnect 34 and anode 24, and/or between secondary interconnect 34 and anode conductive layer 22, and/or between the secondary interconnect 34 and cathode 28, and/or between the secondary interconnect 34 and a cathode conductive layer 30, which may improve the long-term durability of the secondary interconnect.

As shown in FIG. 3A, a terminal end of a fuel cell tube of a fuel cell system may include an electrochemically inactive cell 31 that includes secondary interconnect 34, conductive bonding paste 36, cathode conductive layer 30, electrolyte 26, and dense barrier 32. Electrochemically inactive cell 31 may be, for example, electrochemically inactive because electrochemically inactive cell 31 does not include an anode, a cathode, or both. The electrochemically inactive cell 31 may be disposed on a major surface of the substrate 14, wherein the major surface is separated from the fuel channel 70 by the substrate 14. A first primary interconnect 16a may electrically couple electrochemically inactive cell 31 to a first fuel cell of an electrochemically active region 33 of a fuel cell tube. The primary interconnect 16a (also known as an “I-via”) may be dense and configured to prevent hydrogen from migrating therethrough. Electrochemically active region 33 may be, for example, electrochemically active because each cell in electrochemically active region 33 may include an anode and a cathode. A second primary interconnect 16b may electrically couple the first fuel cell to a second fuel cell in electrochemically active region 33 of the fuel cell tube. Each of the fuel cells may be disposed on a major surface of the substrate 14. In this way, electrochemically inactive cell 31 may be electrically coupled to a plurality of fuel cells that are electrically coupled in series in electrochemically active region 33 of the fuel cell tube. Electrochemically inactive cell 31 and the plurality of fuel cells of electrochemically active region 33 may be disposed on substrate 14 that separates electrochemically inactive cell 31 and plurality of fuel cells of electrochemically active region 33 from fuel channel 70 of the fuel cell tube.

In accordance with some embodiments of the disclosure, one or more of electrolyte 26 or dense barrier 32 may be configured to inhibit the migration of hydrogen, or another fuel, from fuel channel 70 into secondary interconnect 34. For example, the and location of one or more of electrolyte 26 or dense barrier 32 with respect to substrate 14, fuel channel 70, or the oxidant side (not shown may inhibit the migration of hydrogen, or another fuel, from fuel channel 70 into secondary interconnect 34 when the electrolyte 26 or dense barrier 32 comprises the above mentioned materials. Also, the density, the porosity, or both of one or more of electrolyte 26 and dense barrier 32 may be configured to inhibit the migration of hydrogen, or another fuel, from fuel channel 70 into secondary interconnect 34. The porosity of electrolyte 26 may be, for example, in the range of less than 20%, or, for example, than 5%. The porosity of dense barrier 32 may be, for example, less than 20%, or, for example, less than 5%. In this way, electrochemically inactive cell 31 of FIG. 3A provides a barrier to inhibit the migration of hydrogen, or another fuel, from fuel channel 70 into secondary interconnect 34. In fuel cell systems in which at least one or more fuel cell system layers and the relative position of the layers are not configured to inhibit the migration of fuel, e.g. hydrogen, the fuel may migrate from the fuel channel into and through one or more fuel cell system components into secondary interconnect 34.

In accordance with some embodiments, the dense barrier 32, electrolyte 26, or both of the electrochemically inactive cell 31 are gastight (i.e., prohibit the migration of H₂) in the vertical direction of FIG. 3A. Similarly, the primary interconnect 16a, electrolyte 26, or both are gastight to prevent hydrogen from migrating from the active to inactive fuel cells regions 33 and 31, respectively, in the horizontal direction. A sealing glass (not shown) may be applied to the fuel cell tube substrate 14, dense barrier 32, electrolyte 26, and CCC 30 to provide a gas tight barrier to seal the edge of the fuel cell tube.

System 10 shown in FIG. 3B may be substantially the same as system 10 in FIG. 3A. As shown in FIG. 3B, electrochemically inactive cell 31 may include secondary interconnect 34, conductive bonding paste 36, cathode conductive layer 30, and electrolyte 26 and does not include dense barrier 32. In such examples, electrolyte 26 may be configured to inhibit the migration of hydrogen, or another fuel, from fuel channel 70 into secondary interconnect 34. For example, the location of electrolyte 26 with respect to substrate 14, fuel channel 70, or the oxidant side (not shown) may inhibit the migration of hydrogen, or another fuel, from fuel channel 70 into secondary interconnect 34. Also, for example, either or both of the density or the porosity of electrolyte 26 may be configured to inhibit the migration of hydrogen, or another fuel, from fuel channel 70 into secondary interconnect 34. In this way, electrochemically inactive cell 31 of FIG. 3B provides a barrier to inhibit the migration of hydrogen, or another fuel, from fuel channel 70 into secondary interconnect 34.

System 10 shown in FIG. 3C may be substantially the same as system 10 in FIG. 3A. As shown in FIG. 3C, electrochemically inactive cell 31 may include secondary interconnect 34, conductive bonding paste 36, cathode conductive layer 30, and dense barrier 32, and does not include electrolyte 26. In such examples, dense barrier 32 may be configured to inhibit the migration of hydrogen, or another fuel, from fuel channel 70 into secondary interconnect 34. For example, the location of one or more of cathode conductive layer 30 or dense barrier 32 with respect to substrate 14, fuel channel 70, or the oxidant side (not shown) may inhibit the migration of hydrogen, or another fuel, from fuel channel 70 into secondary interconnect 34. Also, for example, either or both of the density or the porosity of dense barrier 32 may be configured to inhibit the migration of hydrogen, or another fuel, from fuel channel 70 into secondary interconnect 34. In this way, electrochemically inactive cell 31 of FIG. 3C provides a barrier to inhibit the migration of hydrogen, or another fuel, from fuel channel 70 into secondary interconnect 34.

System 10 shown in FIG. 3D may be substantially the same as system 10 in FIG. 3A. As shown in FIG. 3D, electrochemically inactive cell 31 may include secondary interconnect 34, conductive bonding paste 36, and cathode conductive layer 30, and does not include electrolyte 26 or dense barrier 32.

Though FIGS. 3A-3D show secondary interconnect 34 disposed on and electrically coupled to electrochemically inactive cell 31, where electrochemically inactive cell 31 is disposed adjacent to and electrically coupled to an anode of a fuel cell, it is understood that electrochemically inactive cell 31 may be disposed adjacent to and electrically coupled to a cathode of a fuel cell. Also, it is understood that secondary interconnect 34 may be disposed on an electrochemically active cell. For example, secondary interconnect 34 may be disposed on cathode conductive layer 30 of an electrochemically active cell including secondary interconnect 34, cathode conductive layer 30, cathode 28, electrolyte 26, anode 24, and anode conductive layer 22.

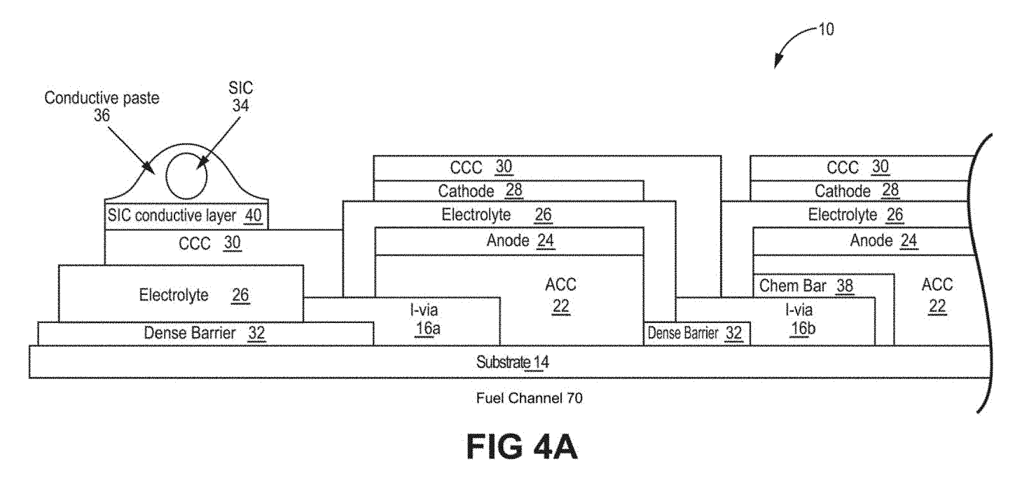

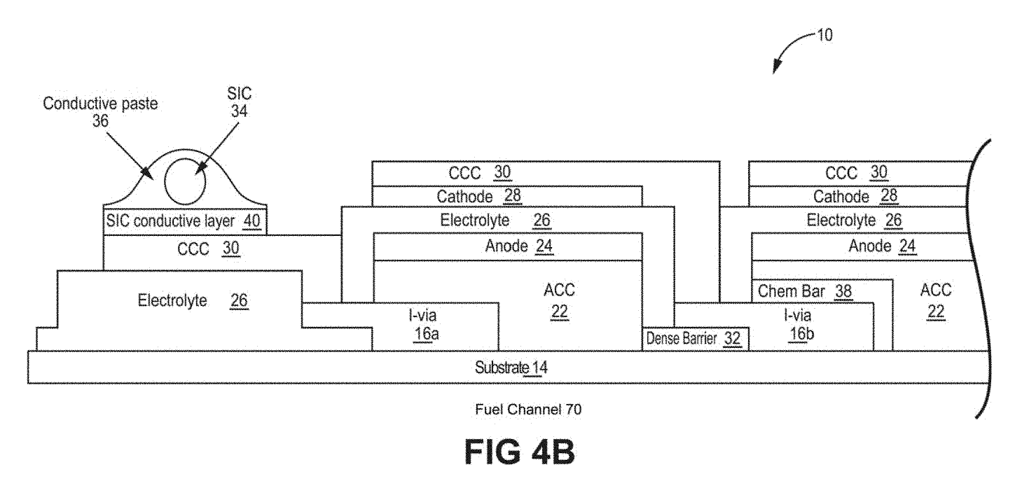

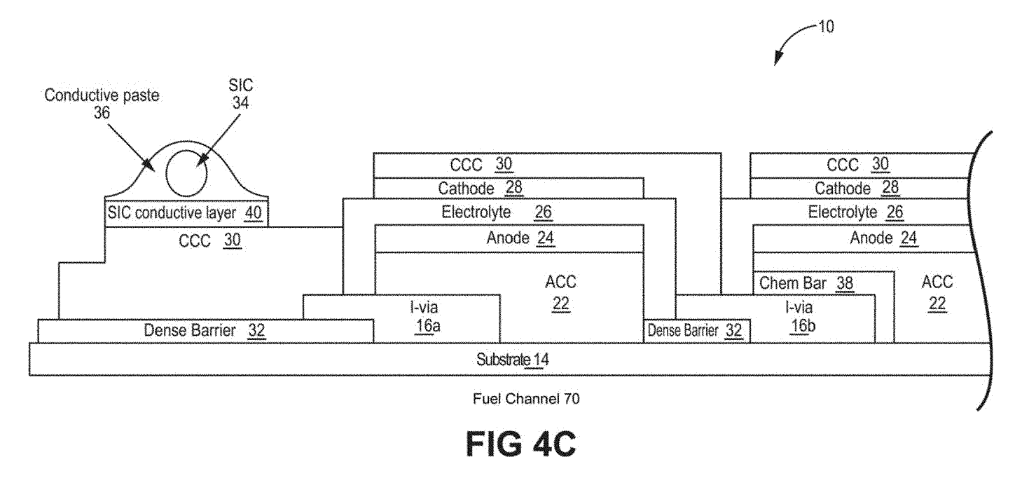

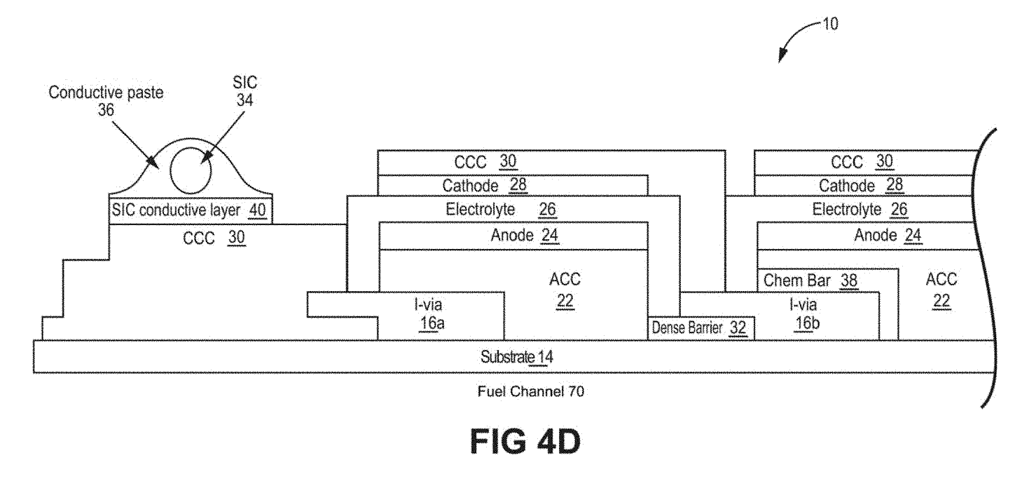

FIGS. 4A-4D are schematic diagrams illustrating an example cross section of a portion of a fuel cell system 10 in accordance with the present disclosure. System 10 of FIGS. 4A-4D may be substantially the same as system 10 of FIG. 3A-3D, respectively, and incorporates the features discussed above with respect to system 10 shown in FIGS. 3A-3D with the addition of secondary interconnect conductive layer 40. While SIC layer 40 is shown in FIGS. 4A-4D has being electrically coupled to the anode 24 of an active fuel cell, SIC layer 40 may also be applied to the CCC 30 of an active cell. This CCC layer may be an “extended” layer in that it extends beyond the active cell region, toward the tube edge, end, or both, into an area that would occupied by the inactive cell for an anode-connected SIC layer 40. In some examples, secondary interconnect 34 may be formed directly on secondary interconnect conductive layer 40. In some examples, secondary interconnect 34 may be formed on a layer other than secondary interconnect conductive layer 40. In some examples, secondary interconnect 34 may be bonded to secondary interconnect conductive layer 40 with conductive bonding paste 36.

In some examples, secondary interconnect conductive layer 40 may be electrically conductive. For example, secondary interconnect conductive layer 40 may be formed of a precious metal, including, for example, Ag, Pd, Au, or Pt, although other materials may be employed without departing from the scope of the present disclosure. For example, it is contemplated that other materials may be employed, including precious metal alloys, such as Ag—Pd, Ag—Au, Ag—Pt, Au—Pd, Au—Pt, Pt—Pd, Ag—Au—Pd, Ag—Au—Pt, Ag—Au—Pd—Pt, as well as binary, ternary, or quaternary alloys in the Pt—Pd—Au—Ag family, inclusive of alloys having minor non-precious metal additions, ferrochrome alloys, cermets composed of a precious metal, precious metal alloy, and an inert ceramic phase, such as alumina, stabilized zirconia, La₂Zr₂O₇, or a ceramic phase with minimum ionic conductivity which will not create significant parasitics, such as YSZ (yttria stabilized zirconia, also known as yttria doped zirconia, wherein yttria doping is 3-8 mol %, preferably 3-5 mol %), ScSZ (scandia stabilized zirconia, wherein scandia doping is 4-10 mol %, preferably 4-6 mol %), doped ceria, and/or conductive ceramics, such as conductive perovskites with A or B-site substitutions or doping to achieve adequate phase stability and/or sufficient conductivity as an interconnect, e.g., including at least one of LSM, LSC, LNF, PSM, LSF, LSCF, doped strontium titanate (such as LaₓSr₁₋ₓTiO_{3-δ}, x=0.1 to 0.3), LSCM (La₁₋ₓSrxCr_{1-y}Mn_{y}O₃, x=0.1 to 0.3 and y=0.25 to 0.75), doped yttrium chromites (such as Y₁₋ₓCaₓCrO_{3-δ}, x=0.1-0.3) and/or other doped lanthanum chromites (such as La₁₋ₓCaₓCrO_{3-δ}, where x=0.15-0.3), and conductive ceramics, such as doped strontium titanate, doped yttrium chromites, LSCM (La₁₋ₓSrₓCr_{1-y}Mn_{y}O₃), and other doped lanthanum chromites.

Secondary interconnect conductive layer 40 may improve the current uniformity along the electrochemically inactive cell (or active cell, as appropriate) in the in the direction of the fuel cell tube width. In some examples, secondary interconnect 34 may contact secondary interconnect conductive layer 40 across substantially the entire width of secondary interconnect conductive layer 40 in the direction of the fuel cell tube width. In some examples, secondary interconnect 34 may contact secondary interconnect conductive layer 40 across small portion of the width of secondary interconnect conductive layer 40 in the direction of the fuel cell tube width. For example, the secondary interconnect 34 may contact less than 10 millimeters of the total width of secondary interconnect conductive layer 40, wherein the width is considered from one fuel cell tube edge to the other edge (i.e., perpendicular to the length of the fuel cell channels), or less than 5 millimeters, or less than 1 millimeter. In some embodiments, the secondary interconnect 34 with or without the conducting paste 36 may have a width and thickness that achieve the conductance required of the system.

The electrochemically inactive cells of FIGS. 4A, 4B and 4C each provide one or more barriers to inhibit the migration of hydrogen, or another fuel, from fuel channel 70 into secondary interconnect 34.

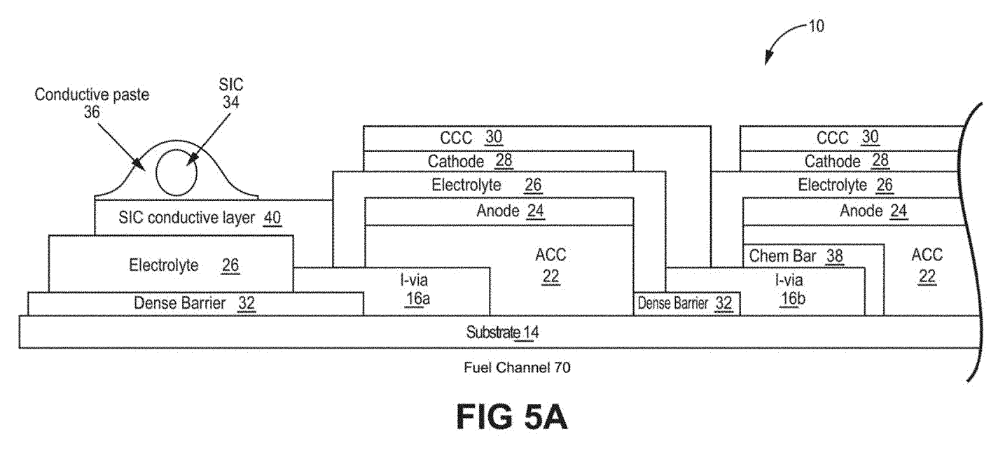

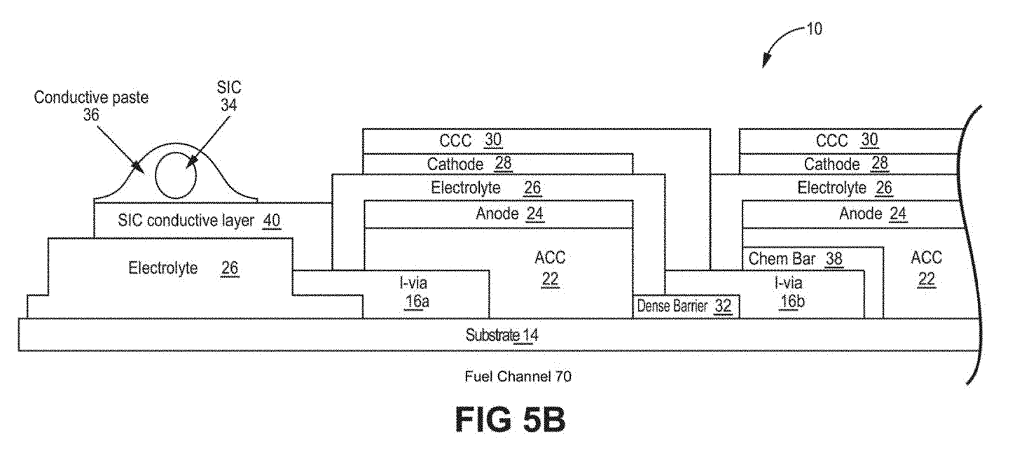

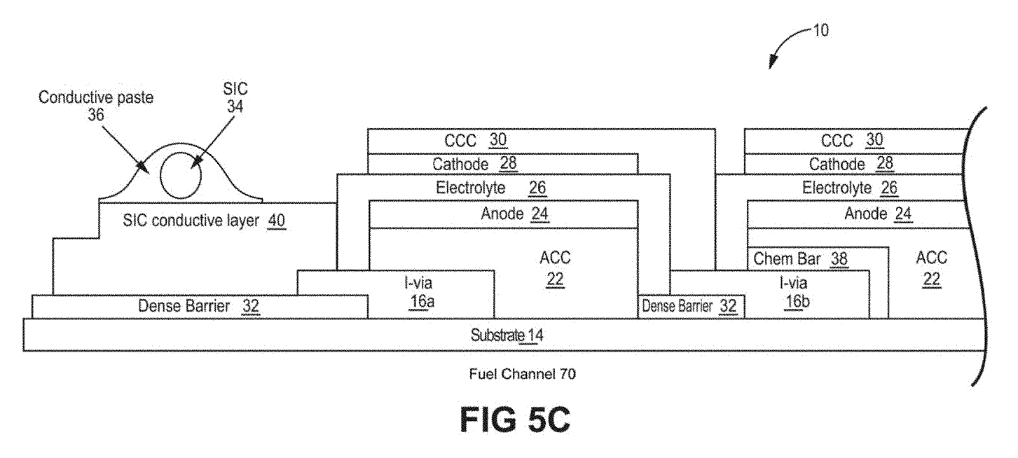

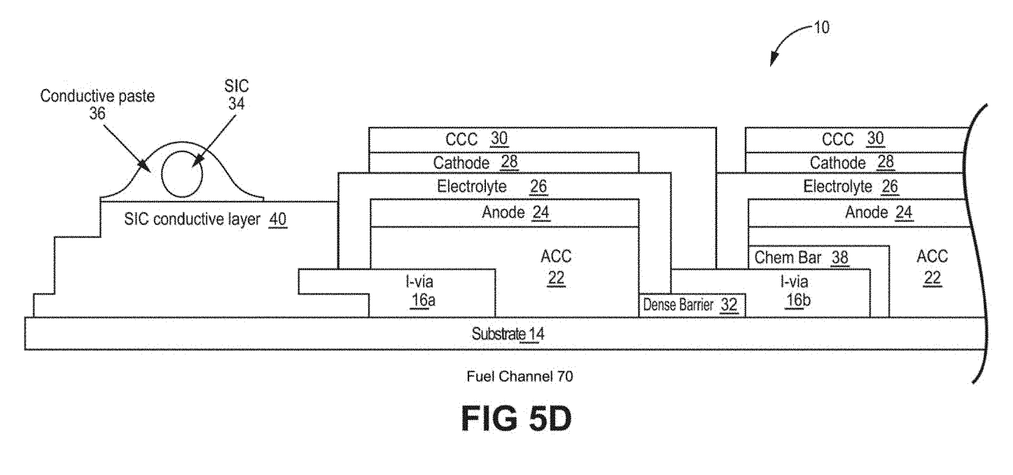

FIGS. 5A-5D are schematic diagrams illustrating an example cross section of a portion of a fuel cell system 10 in accordance with the present disclosure. System 10 shown in FIGS. 5A-5D may be substantially the same as system 10 of FIGS. 4A-4D, respectively, and incorporates the features discussed above with respect to system 10 of FIGS. 4A-4D. However, FIGS. 5A-5D do not include cathode conductive layer 30.

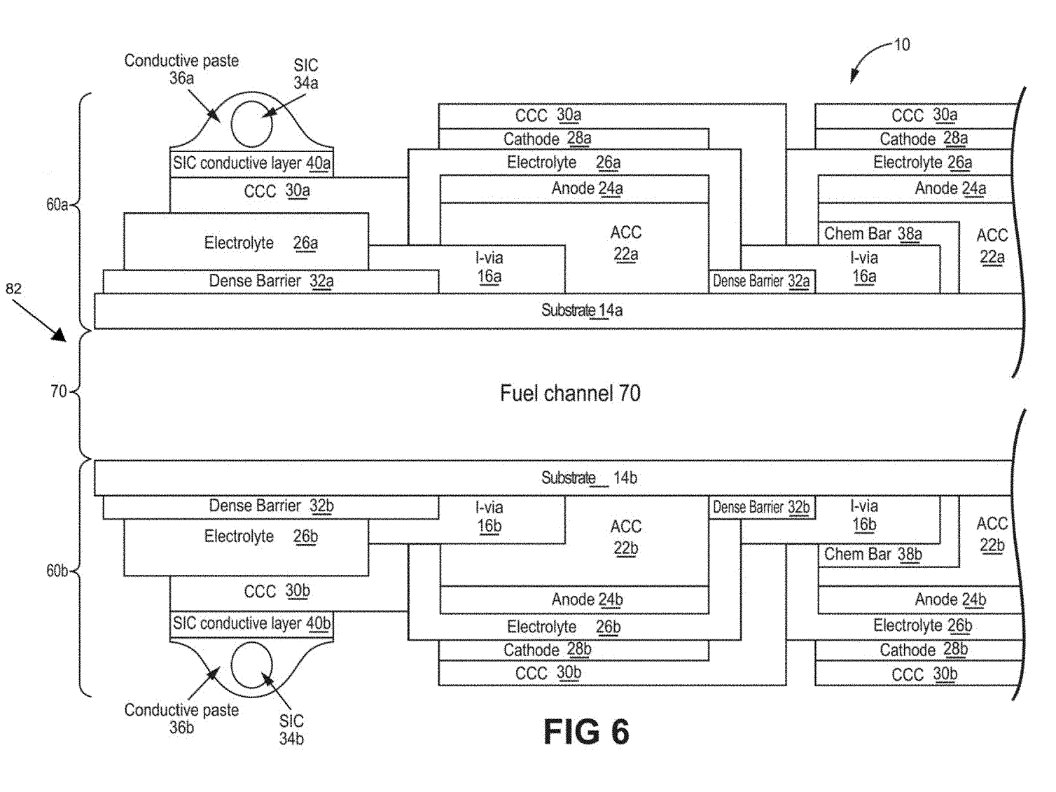

FIG. 6 is a schematic diagram illustrating an example cross section of a portion of a tube of fuel cell system 10 in accordance with the present disclosure. As shown in FIG. 6, electrochemically inactive cells (not labelled in FIG. 6) and plurality of fuel cells in an electrochemically active region (not labelled in FIG. 6), as described above with respect to FIG. 4A, may be disposed on top side 60a and bottom side 60b above and below of fuel channel 70 defined by substrate 14a, 14b, respectively. The surfaces of substrate 14a and 14b onto which the fuel cells are deposited may be referred to as major surface. It is to be understood that the example fuel cell systems 10 of FIGS. 3A-5D may be applied to fuel cell system 10 of FIG. 6. That is, each of the example fuel cell systems 10 of FIGS. 3A-5D may be disposed on a top side 60a and a bottom side 60b of fuel channel 70 defined by substrate 14a, 14b. In this way, the example fuel cell systems 10 of FIGS. 3A-5D may be disposed on a top side 60a and a bottom side 60b of a fuel channel 70 defined by substrate 14a, 14b to define a fuel cell tube.

In some examples, an electrochemically inactive cell is disposed adjacent to and electrically coupled to an anode of a fuel cell. In some examples, the electrochemically inactive cell is disposed adjacent to and electrically coupled to a cathode of a fuel cell.

In some examples, secondary interconnect 34a and secondary interconnect 34b may be electrically coupled to one another. In some examples, secondary interconnects 34a, 34b may be the same wire. In some examples, secondary interconnect 34a and secondary interconnect 34b may be mechanically joined, soldered, or otherwise electrically coupled. In this way, the plurality of fuel cells on top side 60a and the plurality of fuel cells on bottom side 60b may be electrically connected. In some examples, the plurality of fuel cells on top side 60a and the plurality of fuel cells on bottom side 60b may be electrically connected in series. In some examples, the plurality of fuel cells on top side 60a and the plurality of fuel cells on bottom side 60b may be electrically connected in parallel.

In some examples, the tube edge (not shown in FIG. 6) proximate to both the tube end 82 and the electrochemically inactive cells may be sealed with sealing glass (not shown). In some examples, the sealing glass (not shown) inhibits the migration of hydrogen, or another fuel, from fuel channel 70 to the oxidant side and components exposed directly or indirectly to the oxidant. The sealing glass (not shown) provides a gastight seal between fuel channel 70 and the oxidant side. In some examples, the sealing glass (not shown) may be co-fired with conductive paste 36 when bonding secondary interconnect 34 to any one of cathode conductive layer 30 or secondary interconnect conductive layer 40.

In some examples, the fuel cell tube may include at least two fuel cells on top side 60a and at least two fuel cells on bottom side 60b. In some examples, the fuel cell tube may include 100 or 50-60 fuel cells on top side 60a and 100, or 50-60, of fuel cells on bottom side 60b. In some examples, the fuel cell tube may include more than one thousand fuel cells on top side 60a and more than one thousand fuel cells on bottom side 60b.

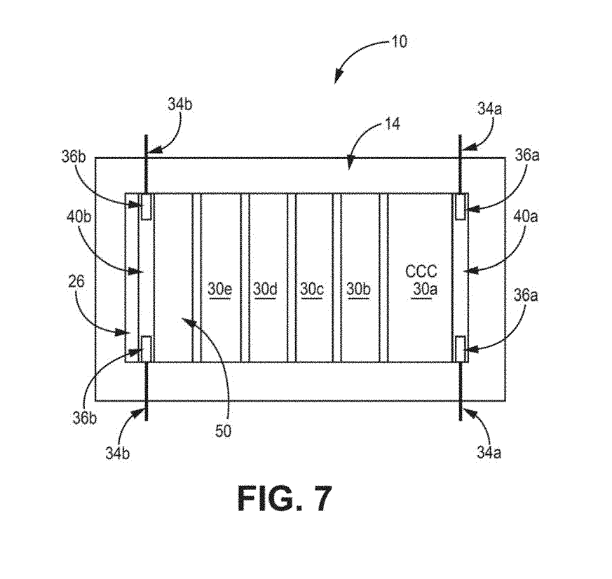

FIG. 7 is a schematic diagram illustrating an example top view of a portion of a fuel cell system 10 in accordance with the present disclosure. As shown in FIG. 7, fuel system 10 may include substrate 14, electrolyte 26, cathode conductive layers 30a-30e, secondary interconnect 34a-34b, conductive bonding paste 36a-36b, secondary interconnect conductive layers 40a-40b, and electrochemically inactive cell. In some examples, secondary interconnect conductive layer 40a may be disposed on a cathode-side, secondary interconnect conductive layer 40b may be disposed on an anode-side, or both. For example, on the anode-side, secondary interconnect conductive layer 40b may be disposed on electrochemically inactive cell 50. Whereas on the cathode-side, for example, secondary interconnect conductive layer 40a may be disposed on cathode conductive layer 30a of an electrochemically active cell. In some examples, cathode conductive layer 30a may be electrochemically active. In some examples, cathode conductive layer 30a may be electrochemically inactive and may extend past the electrochemically active cell toward the tube edge and/or end (i.e., horizontally to the right or vertically in FIG. 7).

In some examples, secondary interconnect conductive layer 40a, 40b may be disposed on an electrochemically active cell in accordance with, for example, the examples as described in FIGS. 4-5. In some examples, secondary interconnect conductive layer 40a, 40b may be disposed on an electrochemically inactive cell in accordance with, for example, the examples as described in FIGS. 4-5.

In some examples, secondary interconnect 34 may be bonded to a bonding site defined by bonding paste 36 on secondary interconnect conductive layer 40 and extend over the boundary defined by substrate 14. For example, cathode-side secondary interconnect 34a may be bonded to a bonding site defined by cathode-side bonding paste 36a on cathode-side secondary interconnect conductive layer 40a and extend over the boundary defined by substrate 14. Similarly, for example, anode-side secondary interconnect 34b may be bonded to a bonding site defined by anode-side bonding paste 36b on anode-side secondary interconnect conductive layer 40b and extend over the boundary defined by substrate 14.

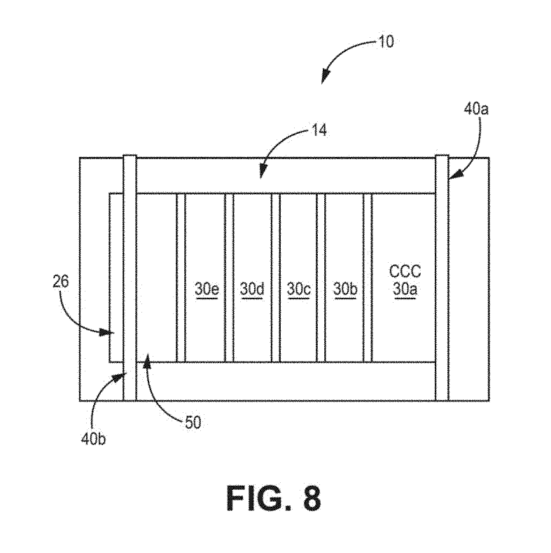

FIG. 8 is a schematic diagram illustrating an example top view of a portion of a fuel cell system in accordance with the present disclosure. As shown in FIG. 8, fuel system 10 may include substrate 14, electrolyte 26, cathode conductive layer 30, secondary interconnect conductive layer 40, and electrochemically inactive cell 50. In some examples, secondary interconnect conductive layer 40a may be disposed on a cathode-side and secondary interconnect conductive layer 40b may be disposed on an anode-side. For example, on the anode-side, secondary interconnect conductive layer 40b may be disposed on electrochemically inactive cell 50. On the cathode-side, for example, secondary interconnect conductive layer 40a may be disposed on cathode conductive layer 30a. In some examples, cathode conductive layer 30a may be electrochemically active. In some examples, cathode conductive layer 30a may be electrochemically inactive.

In some examples, secondary interconnect conductive layer 40a, 40b may be disposed on an electrochemically active cell in accordance with, for example, the examples as described in FIGS. 4-5. In some examples, secondary interconnect conductive layer 40a, 40b may be disposed on an electrochemically inactive cell in accordance with, for example, the examples as described in FIGS. 4-5.

In some examples, secondary interconnect conductive layer 40 may extend over the boundary defined cathode conductive layer 30 or electrochemically inactive cell 50 and may extend proximate to and over a boundary defined by substrate 14 (i.e. the fuel cell tube edge). For example, cathode-side secondary interconnect conductive layer 40a extend over the boundary defined by cathode conductive layer 30a and may extend proximate to and over a boundary defined by substrate 14. Similarly, for example, anode-side secondary interconnect conductive layer 40b extend over the boundary defined by electrochemically inactive cell 50 and may extend proximate to and over a boundary defined by substrate 14. In embodiments wherein the SIC layer 40 is extended beyond the boundary defined by an electrochemical active or inactive cell, the SIC layer 40 may be deposited on top of a sealing glass configured to prevent the migration of H₂ to and through the SIC layer 40.

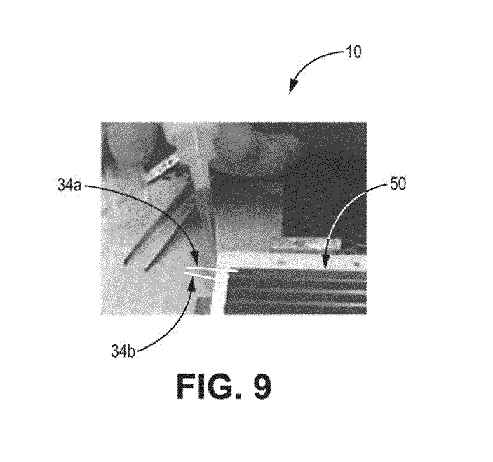

FIG. 9 is a photograph illustrating an example of a secondary interconnect wire attachment and location on a fuel cell tube of a fuel cell system in accordance with the present disclosure. As shown in FIG. 9, fuel cell system 10 may include secondary interconnect 34a on the top side of a portion of electrochemically inactive cell 50 of a portion of a fuel cell tube. Also, as shown in FIG. 9, fuel cell system 10 may include a secondary interconnect 34b on the bottom side of a portion of electrochemically inactive cell (not shown) of a portion of a fuel cell tube. In some examples, secondary interconnect 34a and secondary interconnect 34b may be electrically coupled to connect in parallel the top side of a portion of electrochemically inactive cell 50 and the bottom side of a portion of electrochemically inactive cell (not shown). In some examples, secondary interconnect 34a, 34b may be disposed on the top side and bottom side, respectively, of a portion of a cathode conductive layer (not shown) or a secondary interconnect conductive layer (not shown) of an electrochemically active cell of a fuel cell tube. In some examples, secondary interconnect 34a, 34b may be disposed on the top side and bottom side, respectively, of a portion of a cathode conductive layer (not shown) or a secondary interconnect conductive layer (not shown) of an electrochemically inactive cell of a fuel cell tube.

### Examples

Various experiments were carried out to evaluate one or more aspects of example fuel cell systems in accordance with the disclosure. However, examples of the disclosure are not limited to the experimental fuel cell systems.

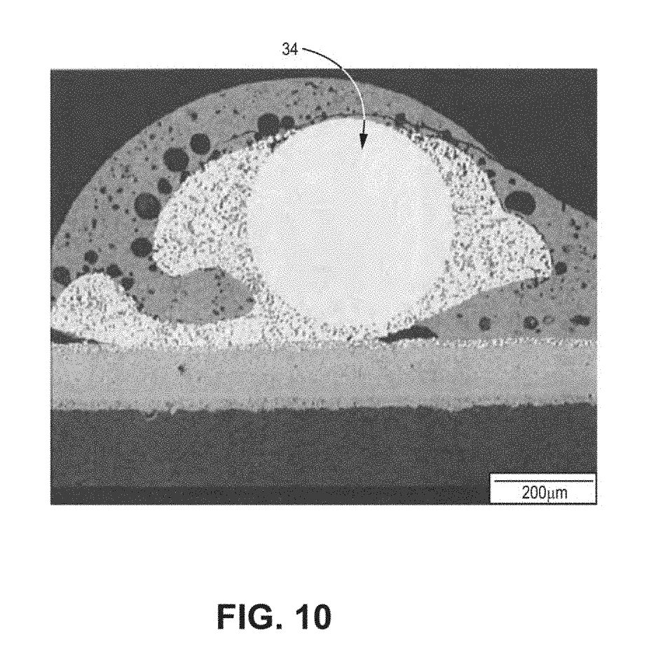

In one instance, a fuel cell system in accordance with an example of the present disclosure was constructed by disposing fuel cells on a substrate, the fuel cell system including a plurality of fuel cells electrically coupled and connected in series with primary interconnects, and a terminal fuel cell on one end of the fuel cell tube including a dense barrier, an electrolyte disposed on the dense barrier, a cathode conductive layer disposed on the electrolyte, and a secondary interconnect wire constructed of Pd disposed on the cathode conductive layer, the secondary interconnect wire bonded to the cathode conductive layer with a Pd-based bonding paste. The dense barrier and electrolyte were configured to inhibit the flow of hydrogen from the fuel channel to the secondary interconnect. The fuel cell system was operated for approximately 2,400 hours. After operation, the Pd secondary interconnect wire microstructure was analyzed. FIG. 10 is an image illustrating the microstructure of the Pd secondary interconnect after approximately 2,400 hours of operation of the fuel cell system in accordance with the present disclosure. A change in microstructure of the Pd secondary interconnect wire may result in loss of mechanical strength or loss of electrical conductivity of the Pd secondary interconnect. As shown in FIG. 10, the Pd secondary interconnect showed no such microstructure change.

In another instance, a fuel cell system in accordance with the present disclosure was constructed by disposing fuel cells on a substrate, the fuel cell system including a plurality of fuel cells, one on a top surface and one on a bottom surface of a substrate/tube, electrically coupled and connected in series with primary interconnects, two secondary interconnect conductive layers disposed on each of an electrochemically inactive cell (“anode side”) and an electrochemically active cathode cell (“cathode side”), two secondary interconnect wires each bonded with conductive bonding paste to opposing edges on the upper surface of the secondary interconnect conductive layer disposed on the electrochemically inactive cell (anode side), and two secondary interconnect wires each bonded with conductive bonding paste to opposing edges on the upper surface of the secondary interconnect conductive layer disposed on the electrochemically active cell (cathode side). The respective SIC wires at each end and edge were bonded together to electrically couple the fuel cells on the top and bottom surfaces. The fuel cell system was operated up to approximately 17,520 hours with stable SIC wires that showed no significant microstructural change.

In another instance, a fuel cell system including fuel cell bundles in accordance with the present disclosure were operated for approximately 4,000 hours with no significant microstructure change in the secondary interconnect.

In another instance, a fuel cell system including fuel cell blocks in accordance with an example of the present disclosure were operated for approximately 3,000 hours with no significant microstructure change in the secondary interconnect.

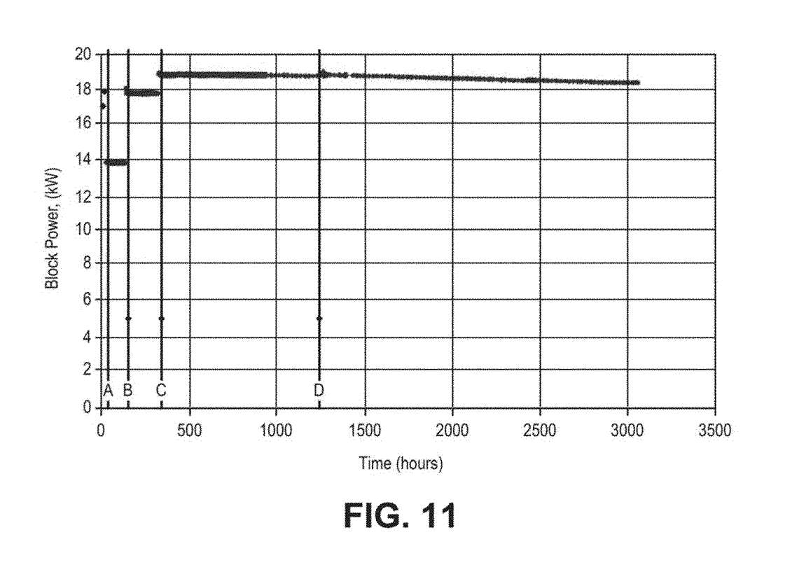

FIG. 11 is a plot illustrating the power generated over time by a fuel cell system in accordance with the present disclosure. As shown in FIG. 11, the fuel cell system output slightly decreased from around 19 kW at around 400 hours of operation to around 18.5 kW after 3000 hours, resulting in a power degradation rate of about 1.1% per 1,000 hours of operation during about 3,000 total hours of operation.

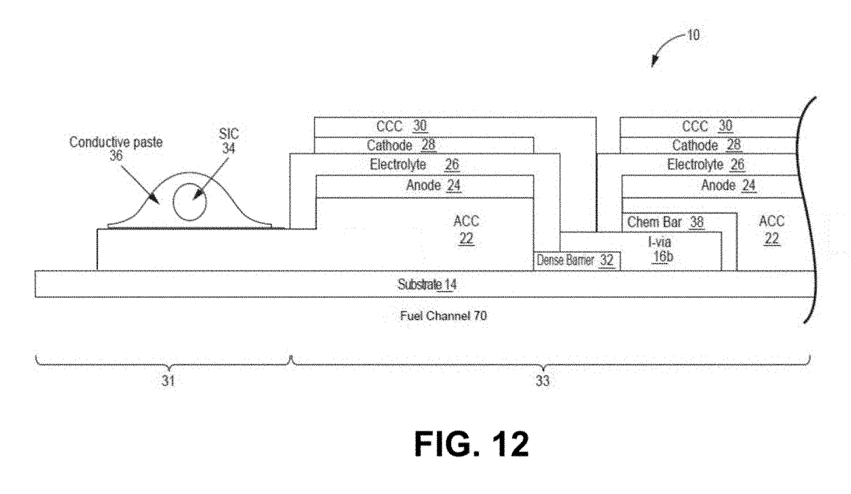

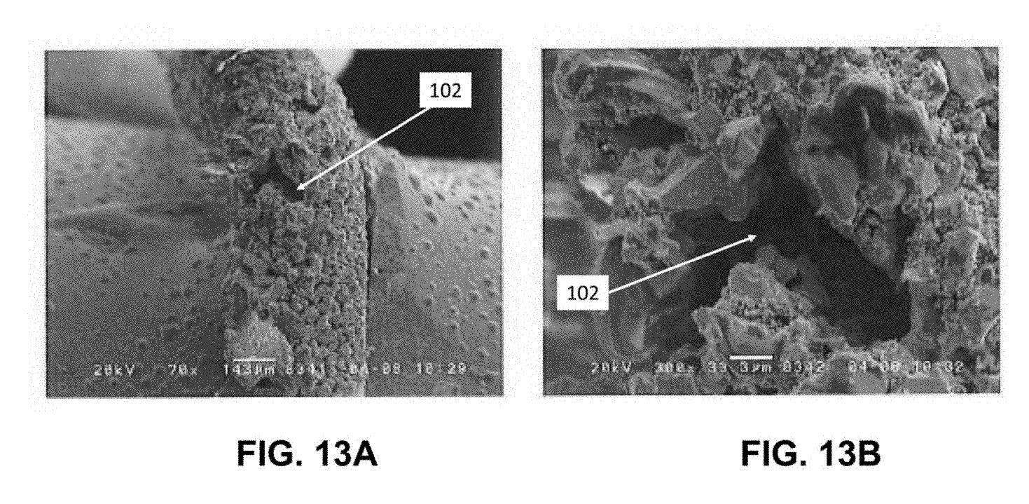

The improved SIC wire and fuel cell system power output illustrated in FIG. 10 and FIG. 11, respectively, compares well to other fuel cell system secondary interconnect designs. One of these other SIC designs is illustrated in FIG. 12. In this design, the SIC wire 34, conductive paste 36, or both are in direct contact with the porous ACC 22 which is in direct contact with the porous substrate 14. Both the ACC 22 and Substrate 14 are porous and designed to allow the migration of fuel to the anode 24. However, this porous nature and fuel-providing function also allow migration of fuel (e.g., H₂) to the SIC wire 34, which may lead to damage of the SIC wire 34 as described above. This surface damage/microstructural change to a Pd wire can be seen in FIGS. 13A and 13B, in which the damage is labeled 102.

Various examples of the invention have been described. These and other examples are within the scope of the following claims.

We claim:

1. A segmented-in-series solid oxide fuel cell system comprising:
a fuel cell tube comprising:
a substrate having a major surface;
a fuel channel separated from said major surface by said substrate;
a first and second electrochemically active fuel cells disposed on said major surface, each of said electrochemically active fuel cells comprising:
an anode;
a cathode; and
an electrolyte disposed between said anode and said cathode;
a primary interconnect electrically coupling the anode of said first electrochemically active fuel cell to the cathode of said second electrochemically active fuel cell;
an electrochemically inactive cell disposed on said major surface, said electrochemically inactive cell comprising a conductive layer electrically coupled to the second electrochemically active fuel cell; and
a secondary interconnect electrically coupled to said conductive layer of said electrochemically inactive cell,
wherein said electrochemically inactive cell is configured to inhibit migration of hydrogen from said fuel channel to said secondary interconnect.

2. The fuel cell system of claim 1 wherein said conductive layer of said electrochemically inactive cell is electrically coupled to the anode of said second electrochemically active fuel cell.

3. The fuel cell system of claim 2 further comprising a second primary interconnect electrically coupling the conductive layer of said electrochemically inactive cell and the anode of said second electrochemically active fuel cell.

4. The fuel cell system of claim 2 wherein said electrochemically inactive cell further comprises a second conductive layer disposed between said secondary interconnect and said conductive layer.

5. The fuel cell system of claim 2 wherein said second conductive layer comprises a precious metal and a ceramic.

6. The fuel cell system of claim 2 wherein said electrochemically inactive cell further comprises an electrolyte disposed between said conductive layer and said major surface of said substrate.

7. The fuel cell system of claim 6 wherein said electrochemically inactive cell further comprises a second conductive layer disposed between said secondary interconnect and said conductive layer.

8. The fuel cell system of claim 6 wherein said electrochemically inactive cell further comprises a dense barrier disposed between the electrolyte and said major surface of said substrate.

9. The fuel cell system of claim 8 wherein said electrochemically inactive cell further comprises a second conductive layer disposed between said secondary interconnect and said conductive layer.

10. The fuel cell system of claim 2 wherein said electrochemically inactive cell further comprises a dense barrier disposed between said conductive layer and said major surface of said substrate.

11. The fuel cell system of claim 10 wherein said electrochemically inactive cell further comprises a second conductive layer disposed between said secondary interconnect and said conductive layer.

12. The fuel cell system of claim 2 wherein said secondary interconnect is at least partly buried by a conductive bonding paste.

13. The fuel cell system of claim 2 wherein said secondary interconnect comprises a palladium wire.

14. The fuel cell system of claim 2 wherein said conductive layer comprises a precious metal and a ceramic.

15. The fuel cell system of claim 2 wherein each of said electrochemically active fuel cells further comprises a cathode conductive layer electrically coupled to said cathode, and wherein the conductive layer of said electrochemically inactive cell is formed from the same material as each of said cathode conductive layers.

16. The fuel cell system of claim 1 wherein said secondary interconnect is at least partly buried by a conductive bonding paste.

17. The fuel cell system of claim 1 wherein said secondary interconnect comprises a palladium wire.

18. The fuel cell system of claim 1 wherein said conductive layer comprises a precious metal and a ceramic.

19. A segmented-in-series fuel cell system comprising:
a substrate having a first major surface second major surface;
a fuel channel disposed between the first and second major surfaces, wherein the fuel channel is separated from the first and second major surfaces by the substrate;
a first and second electrochemically active fuel cells disposed on the first major surface and a third and fourth electrochemically active fuel cells disposed on the second major surface, each of said electrochemically active fuel cells comprising:
an anode;
a cathode; and
an electrolyte disposed between said anode and said cathode;
a first primary interconnect electrically coupling the anode of the first electrochemically active fuel cell to the cathode of the second electrochemically active fuel cell;
a second primary interconnect electrically coupling the anode of the third electrochemically active fuel cell to the cathode of the fourth electrochemically active fuel cell;
a first electrochemically inactive cell disposed on the first major surface and a second electrochemically inactive cell disposed on the second major surface, each of the electrochemically inactive cells comprising a conductive layer electrically coupled to at least one of the electrochemically active fuel cells; and
a secondary interconnect electrically coupled to the conductive layer of the first and second electrochemically inactive cells,
wherein the electrochemically inactive cells are configured to inhibit migration of hydrogen from the fuel channel to the secondary interconnect.

20. A fuel cell tube comprising:
a substrate having a major surface;
a fuel channel separated from the major surface by the substrate;
at least one electrochemically active cell disposed on the major surface comprising:
an anode;
a cathode; and
an electrolyte disposed between the anode and the cathode;
an electrochemically inactive cell disposed on the major surface, the electrochemically inactive cell comprising:
a conductive layer;
an electrolyte disposed between said conductive layer and the major surface of said substrate; and
a dense barrier disposed between the electrolyte and the major surface of said substrate; and
a primary interconnect electrically coupling the anode of the electrochemically active cell and the conductive layer; and
a secondary interconnect comprising palladium electrically coupled to the conductive layer of the electrochemically inactive cell, wherein the secondary interconnect is at least partly buried by a conductive bonding paste.
